(19) United States
(12) Patent Application Publication
(10) Pub. No.: US 2026/0058053 A1
(43) Pub. Date: Feb. 26, 2026

(54) Planar Magnetic-Electrical Power Train With Multiple Power Processing Cells Arranged Across Several Branches

(71) Applicant: Rompower Technology Holdings, LLC, Milford, DE (US)

(72) Inventor: Ionel Jitaru, Tucson, AZ (US)

(73) Assignee: Rompower Technology Holdings, LLC, Milford, DE (US)

(21) Appl. No.: 19/379,679

(22) Filed: Nov. 4, 2025

Related U.S. Application Data
(63) Continuation-in-part of application No. 19/227,373, filed on Jun. 3, 2025, now Pat. No. 12,462,973.
Application No. 19/227,373 is a continuation-in-part of application No. 18/368,513, filed on Sep. 14, 2023, now Pat. No. 12,322,541.
Application No. 18/368,513 is a continuation of application No. 17/845,609, filed on Jun. 21, 2022, now Pat. No. 11,763,984.
Application No. 17/845,609 is a continuation of application No. 17/189,096, filed on Mar. 1, 2021, now Pat. No. 11,367,565.
Application No. 17/189,096 is a continuation-in-part of application No. 16/368,186, filed on Mar. 28, 2019, now Pat. No. 10,937,590.
Application No. 16/368,186 is a continuation of application No. 14/660,901, filed on Mar. 17, 2015, now abandoned.
(60) Provisional application No. 61/955,640, filed on Mar. 19, 2014.
(60) Provisional application No. 63/133,076, filed on Dec. 31, 2020.
(60) Provisional application No. 63/878,318, filed on Sep. 9, 2025.
(60) Provisional application No. 63/907,017, filed on Oct. 28, 2025.

(51) Int. Cl. H01F 30/06; H01F 27/245

(52) U.S. Cl. CPC H01F 30/06; H01F 27/245

(57) ABSTRACT

A planar magnetic-electrical power train suitable for large voltage step down and high current application is formed by a number of branches, wherein each branch is formed by a plurality of power processing cells wherein the high output current is extracted uniformly with minimum losses. The planar magnetic-electrical power train is inherently flexible to accommodate diverse form factors. The effective turns ratio is set by the number of turns or layers allocated to the primary and the cell count. The use of an optimized U core allows a simple implementation of fractional turns and the flexibility to tailor the power capability and the desired turns ratio. Output current is drawn in parallel from all cells, permitting distributed placement of output capacitors on each cell and thereby reducing conduction losses and current crowding.

### CROSS-REFERENCE TO RELATED APPLICATIONS

This application is a continuation-in-part of and claims the benefit of prior U.S. patent application Ser. No. 19/227,373, filed Jun. 3, 2025, which is a continuation-in-part of and claims the benefit of prior U.S. patent application Ser. No. 18/368,513, filed Sep. 14, 2023, which is a continuation of and claims the benefit of prior U.S. patent application Ser. No. 17/845,609, filed Mar. 21, 2022, which is a continuation of and claims the benefit of prior U.S. patent application Ser. No. 17/189,096, filed Mar. 1, 2021, which is a continuation-in-part of and claims the benefit of prior U.S. patent application Ser. No. 16/368,186, filed Mar. 28, 2019, which is a continuation of and claims the benefit of prior U.S. patent application Ser. No. 14/660,901, filed Mar. 17, 2015, which claims the benefit of U.S. Provisional Application No. 61/955,640, filed Mar. 19, 2014. Prior U.S. patent application Ser. No. 17/189,096 also claims the benefit of U.S. Provisional Application No. 63/133,076, filed Dec. 31, 2020. This application also claims the benefit of U.S. Provisional Application No. 63/907,017, filed Oct. 28, 2025, and of U.S. Provisional Application No. 63/878,318, filed Sep. 9, 2025. All of the above applications are hereby incorporated by reference in their entireties.

### FIELD

The present specification relates generally to electronic devices, and more particularly to magnetic structures in power conversion.

### BACKGROUND

Designers of modern power converters continue to push for smaller, lower-profile solutions. This trend places similar demands on the magnetic components-transformers and inductors-used within those converters. To improve manufacturing consistency, many of these magnetic windings are now integrated directly into multilayer printed circuit board (PCB) structures, but this approach limits the available copper thickness and the number of usable layers.

Engineers addressing higher-current applications with thin copper and limited layer counts have developed several approaches. At the same time, advancements in semiconductor technology have influenced magnetic design requirements. Power semiconductor devices now offer extremely small footprints and very low on-resistance values, enabling them to conduct high currents in compact form factors. There is a continuing need to manage substantially higher currents while maintaining small footprints.

### SUMMARY

In an embodiment, a power processing cells include a magnetic element including identical magnetically conductive first and second posts positioned between two magnetic flux conductive plates, wherein the plates are configured to ensure a continuous flow of a magnetic field through the first and second posts, a multilayer electrically conductive structure with openings for the first and second posts, containing stacked layers wherein at least one of the layers forms primary and secondary transformer windings. The primary transformer winding is located within the multilayer electrically conductive structure, encircling the first and second posts, each with an induced magnetic field of opposite polarity to the other. The secondary transformer winding includes at least two secondary layers in the multilayer electrically conductive structure, with one of the secondary layers at a top and another of the secondary layers at a bottom. Semiconductor devices are on at least one of the secondary layers, electrically connected to the secondary transformer winding. Output capacitors are on at least one of the secondary layers, electrically connected to the secondary transformer winding and the semiconductor devices. Electrically conductive pads are positioned between the first and second posts, and electrically connected to the semiconductor devices and the output capacitors. A current is induced through the semiconductor devices, the output capacitors, and the electrically conductive pads around the first and second posts, by the magnetic field from a current flow of the primary transformer winding. The current flow generates a voltage across the output capacitors, with one termination at a Vo+ terminal and the other at a GND terminal. All of the output capacitors are connected in parallel within the power processing cells. The Vo+ terminals are electrically joined, and the GND terminals are electrically joined, wherein shared GND and Vo+ terminals define a common ground and a positive output, respectively.

In an embodiment, a planar magnetic-electrical power train branch includes a frequency of operation and a period T, wherein period T is an inverse of the frequency of operation, a primary and a secondary, an input power source in the primary, an output in the secondary, at least two totem pole power devices connected to the input power source, a resonant capacitor connected to a common connection of the at least two totem pole power devices, defining a switching node, and a plurality of power processing cells according to claim 1, wherein the primary transformer windings of said power processing cells are connected in series and further connected to the resonant capacitor.

In embodiments of the planar magnetic-electrical power train branch, each of the power processing cells further includes at least one inner layer forming an external ring encircling an outside of both the first and second posts. Each branch operates at a same frequency and is successively delayed by a fraction of T, so as to reduce RMS current across the output capacitors in all the power processing cells of every branch. The planar magnetic-electrical power train includes an even number of planar magnetic-electrical power train branches, wherein the branches are arranged in pairs and each pair operates at a same frequency but is offset by T/2 relative to the other, so as to cancel out common mode noise generated by a displacement current across a parasitic capacitance between the primary and secondary transformer windings of each processing power cell transformer. The planar magnetic-electrical power train includes multiple planar magnetic-electrical power train branches, each including power processing cells within one multilayer conductive structure, wherein the Vo+ and GND connect to pins interfacing with a motherboard which aggregates current from all of the power processing cells via the pins. The planar magnetic-electrical power train includes multiple planar magnetic-electrical power train branches, each including power processing cells within a plurality of multilayer conductive structures, wherein the Vo+ and GND connect to pins interfacing with a motherboard which aggregates current from the plurality of multilayer conductive structures via the pins. The planar magnetic-electrical power train includes multiple planar magnetic-electrical power train branches, each including power-processing cells within a multilayer conductive structure wherein in each branch, an even number of magnetic posts are between the magnetically conductive plates covering said posts. The planar magnetic-electrical power train includes multiple planar magnetic-electrical power train branches, wherein each branch includes power processing cells embedded within a multilayer electrically conductive structure, and the first and second posts of each branch are inserted into the multilayer conductive structure and are positioned between magnetically conductive plates that fully enclose all posts. The planar magnetic-electrical power train includes multiple planar magnetic-electrical power train branches according to claim 2, wherein each branch is implemented on a distinct multilayer electrically conductive structure formed by the power processing cells, wherein Vo+ and GND are interconnected through internal layers and are inserted and electrically connected within a motherboard which aggregates current from all of the power processing cells across every branch. The planar magnetic-electrical power train includes branches, each operating at a same frequency and sequentially delayed by a fraction of T, so as to reduce RMS current through the output capacitors in every power processing cell. The planar magnetic-electrical power train includes branches arranged in pairs, wherein each pair operates at a same frequency but is offset by T/2 relative to the other, so as to cancel out common mode noise generated by a displacement current across a parasitic capacitance between the primary and secondary transformer windings of each processing power cell. The planar magnetic-electrical power train branch includes multiple power processing cells, wherein each primary transformer winding is configured around the first and second posts of each respective power processing cell to establish fractional turns within the respective power processing cell.

In an embodiment, power processing cells include a magnetic element having two identical magnetically conductive first and second posts between two magnetic flux conductive plates, wherein the plates are configured to ensure a continuous flow of a magnetic field through the first and second posts. It includes a multilayer electrically conductive structure with openings for the first and second posts, containing stacked layers wherein at least one of the layers forms primary and secondary transformer windings. The primary transformer winding is located within the multilayer electrically conductive structure, encircling the first and second posts, each with an induced magnetic field of opposite polarity to the other. The secondary transformer winding includes at least two secondary layers in the multilayer electrically conductive structure, with one of the secondary layers at a top and another of the secondary layers at a bottom. At least two semiconductor devices are in series on at least one secondary layer, electrically connected to the secondary transformer windings. Output capacitors are on at least one of the secondary layers, electrically connected to the secondary windings and semiconductor devices. Electrically conductive pads are positioned between the first and second posts, and electrically connected to the semiconductor devices and the output capacitors. A current is induced through the semiconductor devices, the output capacitors, and the electrically conductive pads around each of the first and second posts, by the magnetic field from a current flow of the primary winding. The current flow generates a voltage across the output capacitors, with one termination at a Vo+ terminal and the other at a GND terminal. All of the output capacitors are connected in parallel within the power processing cells, the Vo+ terminals are electrically joined and the GND terminals are electrically joined, wherein shared GND and Vo+ terminals define a common ground and positive output.

The above provides the reader with a brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 illustrates the power train described in this specification, including multiple branches, each with a series of power processing cells;

FIG. 2 illustrates the conceptual schematic of a branch created by power processing cells;

FIG. 2a illustrates the top layer configuration of a power processing cell;

FIG. 2b illustrates the bottom layer configuration of a power processing cell;

FIG. 2x illustrates a conceptual schematic of a branch formed by power processing cells, in which a discrete LLC inductor is incorporated;

FIG. 3a shows the top view of a multilayer electrically conductive structure with integrated power components and no magnetic core;

FIG. 3b shows a multilayer electrically conductive structure with integrated power components and a magnetic core;

FIG. 3c shows the bottom view of a multilayer electrically conductive structure with integrated power components and no magnetic core;

FIG. 4 shows the U core magnetic element which is used in this specification;

FIGS. 5a, 5b, 5c, 5d, and 5e show different power train implementations built with a standard U shape core;

FIG. 6a is a lateral view of a power converter using two multilayer electrically conductive structures in parallel connected by power pins;

FIG. 6b is a perspective view of a power converter using two multilayer electrically conductive structures in parallel connected by power pins;

FIG. 7a is a lateral view of a power converter using two multilayer electrically conductive structures in parallel connected by power pins and linked by the same magnetic core;

FIG. 7b is a perspective view of a power converter using two multilayer electrically conductive structures in parallel connected by power pins and linked by the same magnetic core;

FIG. 8 shows the schematic of a power train using a full bridge rectification;

FIG. 9a illustrates the top layer configuration of a power processing cell using full bridge rectification;

FIG. 9b illustrates the bottom layer configuration of a power processing cell using full bridge rectification;

FIG. 10a illustrates the serpentine winding on one layer;

FIG. 10b illustrates the serpentine winding on a layer connected to the previous layer depicted in FIG. 10a;

FIGS. 11a, 11b, 11c, and 11d illustrate several possible implementation of fractional turns;

FIG. 12a shows a possible implementation of a power train using three branches connected vertically to a mother board;

FIG. 12b shows a possible implementation of a power train using three branches connected vertically to a mother board, wherein two sets of two U cores are merged in two four leg transformer structure;

FIG. 12c shows a possible implementation of a power train using three branches connected vertically to a mother board, wherein four sets of two U cores are merged in one eight leg transformer structure;

FIG. 12d shows an eight magnetic post core which is the result of a merger of four sets of U cores;

FIG. 13a shows two half bridge power train; and

FIGS. 13b and 13c show waveforms in switching node A and B of the half bridges depicted in FIG. 13a.

### DETAILED DESCRIPTION

Reference now is made to the drawings, in which the same reference characters are used throughout the different figures to designate the same elements.

In an embodiment, a planar magnetic-electrical power train suitable for large voltage step down and high current application is formed by a number of branches, wherein each branch is formed by plurality of power processing cells wherein the magnetic termination effect is minimized and wherein the high output current is extracted uniformly with minimum losses. The planar magnetic-electrical power train is inherently flexible to accommodate diverse form factors. The planar transformer of this magnetic-electrical power train is built by locating the path for high current loops on designated layers wherein the power devices are located such as top and bottom layers on a multilayer PCB board or several multilayer PCB boards in parallel. The traces connecting the power devices and the power devices surround the posts of the planar transformer. The primary windings are designed to force the current to flow through traces on designated layers and using a low number of the vias. In one of the embodiments of this specification, the flow of ripple current exchange between parallel power processing cells is done through vias in the multilayer PCB or via high current pins which are also used for extracting the high current from the power processing cells to the output load. The planar magnetic-electrical power train has a large level of flexibility to accommodate different power levels by adjusting the numbers of power processing cells which can be tiled to optimally fill a given volume analogous to links in a chain. The effective turns ratio is set by the number of turns or layers allocated to the primary, the cell count, and the selected magnetic core. The use of one optimized U core allows a simple implementation of fractional turns and the flexibility to tailor the power capability and the desired turns ratio. Output current is drawn in parallel from all cells, permitting distributed placement of output capacitors on each cell and thereby reducing conduction losses and current crowding.

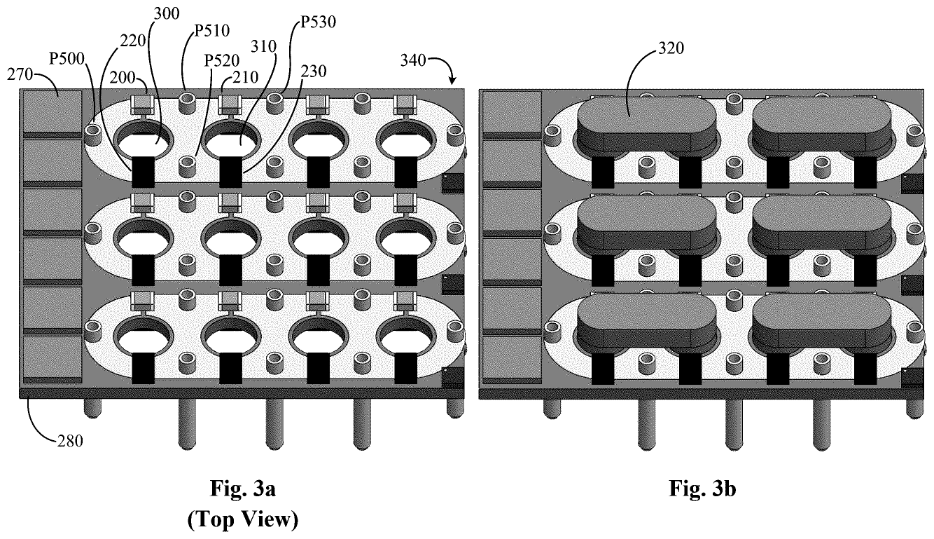

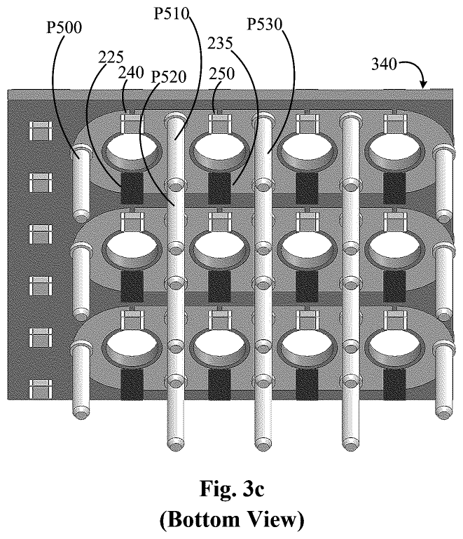

In U.S. Pat. No. 10,937,590, FIGS. 3A and 3B present a power processing cell using a secondary tap winding, 34 and 36 and two rectifier means 30 and 32, power processing cells using a U core which penetrated through a multilayer PCB and two rectifier means. The unidirectional current in the secondary windings flows through the copper trace between the U core legs (34 and 36), then continues via the surrounding copper planes (44 and 46) wherein the current flow is bidirectional.

This secondary winding structure minimizes the impedance of the secondary windings while offering a very good coupling to the primary windings which surround the two posts of the U core.

This structure is an idealized implementation for a center tap secondary. In this secondary winding implementation, only one small section of the winding conducts for each polarity of the voltage induced into the secondary. In addition, in center tap secondary winding there is a leakage inductance in between secondary windings which delays the current flow from one winding to another.

The implementation of the secondary winding depicted in FIGS. 3B and 4B and 6D minimizes issues. The current through the secondary windings flows through the small trace in between the legs of the U core 34 and 36 from FIG. 3B, in only one direction for each polarity. However, the current flow through the secondary winding flows further through a longer path via the copper planes 44 and 46 which surrounds the magnetic core leg of the U core. Current flows in both directions through copper planes 44 and 46, optimizing copper usage. In addition, the leakage inductance in between the secondary windings paths is very small because a large percentage of the secondary current flowing path is the same. For higher current application and higher frequency, a U Core winding implementation is a preferred implementation for secondary center tap.

However, there are some drawbacks of the implementation presented in FIG. 3B, 4B, and 6D. The secondary current flow characterized by high amplitude, flows through copper vias in between layers. The impedance of the copper vias is function of the plating process which is not always consistent.

In U.S. Pat. No. 12,462,973, which is continuing from U.S. Pat. No. 10,937,590, the power processing cell is used for an LLC topology and that is depicted in FIG. 33A.

In FIG. 33C, for one of the phases of the voltage induced in the secondary winding, D1, 374 is conducting and the current flows from the ground plane 384 (V−) through D1, 376, to the copper trace, 386D and further to vias 316 and 315 to the layer 2, 1340. In between layer 1 and Layer 2 are connected the output capacitors CR 1301. During Phase A, the secondary current flows through D1, 376 around the posts, 386A and 386B to cancel the magnetic field induced by the primary winding. During the phase A also the current flows via D2 around the magnetic post 386D and 386C to cancel the magnetic field induced by the primary winding which surround the four posts 386A, 386B, 386C and 386D. Two layers 1323 and 1324 are allocated for the secondary windings and the output current flows via the vias, 315, 316, 318 and 1317.

This implementation uses four magnetic posts magnetic core, and vias are used for directing the flow of the output current. Using four sets of vias for simultaneous conduction helps reduce current crowding.

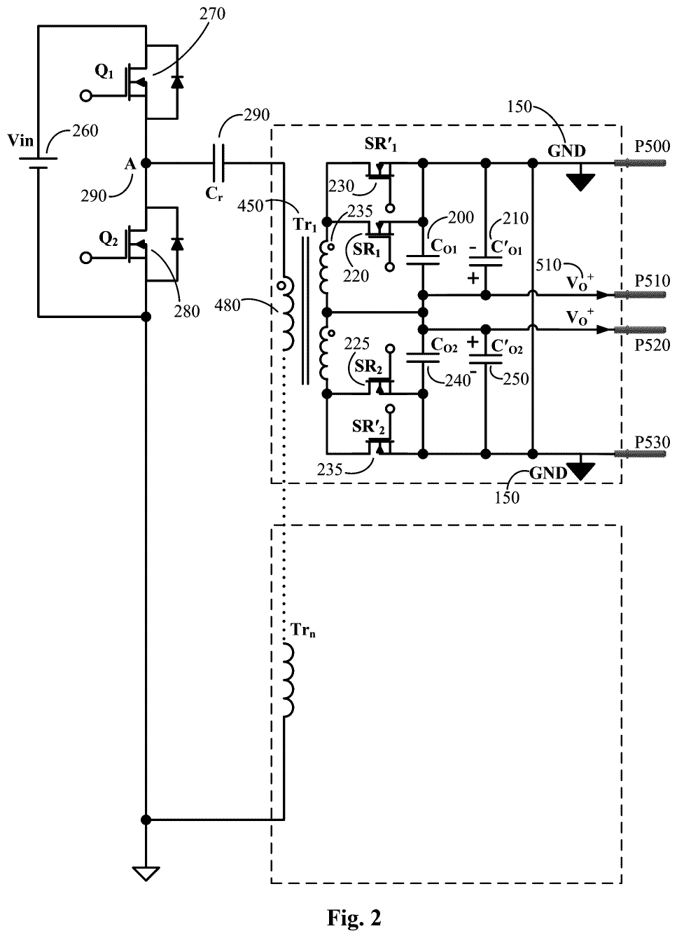

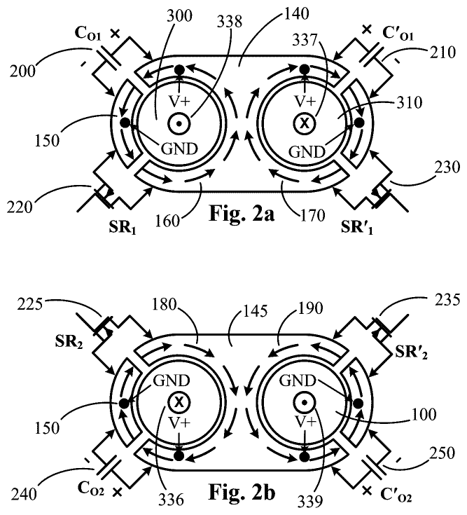

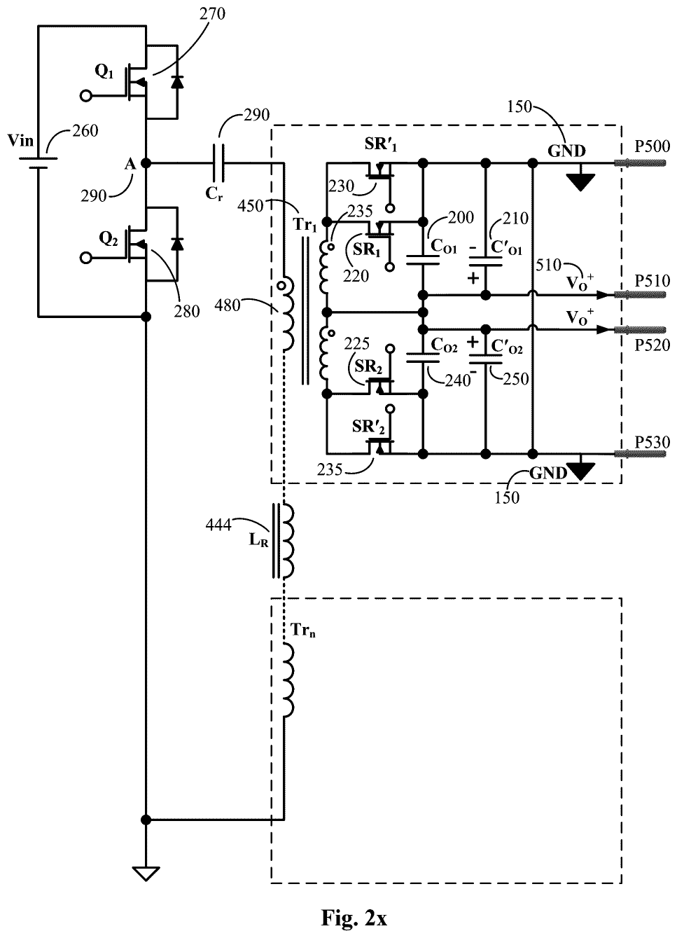

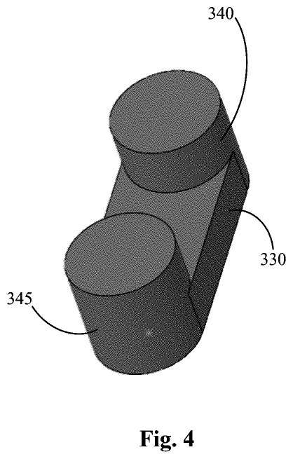

The magnetic-electrical power processing cell is presented in FIG. 2. Each power processing cell includes a transformer cell Tr1, having a primary winding and a secondary winding with a center tap. For the first phase, phase “A”, SR1 and SR1′ conducts and for the second phase, phase “B”, SR2 and SR2′ conducts. Phase “A” occurs when the voltage induced in the secondary winding of the transformer Tr1 is positive at the dot, 235. In FIG. 2a and FIG. 2b is depicted the implementation of the secondary winding and the placement of synchronous rectifiers and also the output capacitors Co1, Co1′ and Co2 and Co2′. The U type core which is the magnetic element used in the power cell has two legs, 340 and 345, as depicted in FIG. 4. Legs 340 and 345 penetrate through the multilayer PCB 340 via the apertures 300 and 310, as presented in FIG. 3a. In FIG. 2a are depicted the currents flowing on the surface, 140 of the multilayer PCB 340, from FIG. 3a. In FIG. 2b are depicted the currents flowing on the surface, 145 of the multilayer PCB 340.

The primary winding which surrounds both legs of the U core, induces a magnetic field in the U core depicted by 338 and 337. Current flows through the conductive material around the magnetic posts, which pass through apertures 300 and 310, to oppose the primary winding's magnetic field. During the initial phase, referred to as phase A, the current flowing through the conductive material surrounding the magnetic post is indicated by 160 and 170. The current labeled 160 passes through the first secondary winding encircling aperture 300, via SR1 (220), and Co1 (200). Current in the second secondary winding flows around aperture 310, depicted by 170, passing through SR1′ (230) and output capacitor C01′. Currents 160 and 170, moving through conductive material around magnetic posts 345 (aperture 300) and 340 (aperture 310), neutralize the magnetic field from primary winding 480 shown in FIG. 2. Power components SR1 (220) and Co1 (200), along with SR1′ (230) and Co1′ (210), are positioned near the magnetic posts 345 and 340, which pass through apertures 300 and 310.

During phase B, current through the primary winding generates a magnetic field (336, 339) that induces currents (180, 190) in the conductor on layer 145. The induced current circulates clockwise through aperture 300 and counterclockwise through aperture 310, then flows via SR2 (225), SR2′ (235), and output capacitors Co2 (240) and Co2′ (250).

On the multilayer PCB (340), the top layer (140) and bottom layer (145) surface layers contain secondary windings and power components.

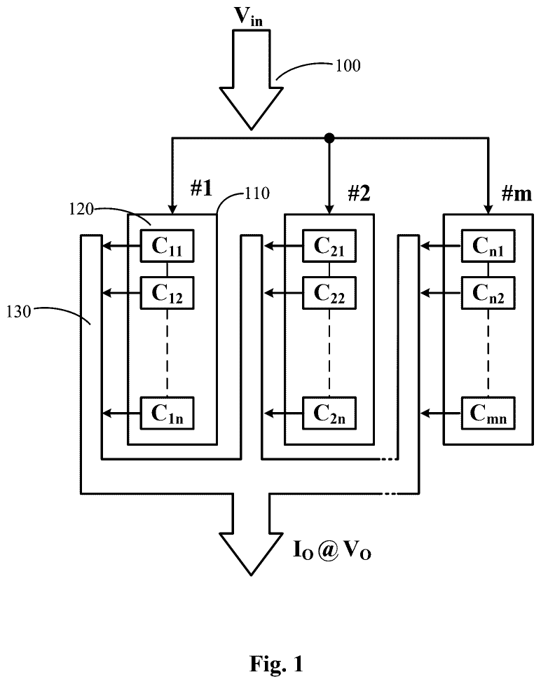

FIG. 1 shows “m” branches, each with “n” power processing cells. The cells on each branch are synchronized by shared primary switchers and primary winding. Cells within each branch are arranged to introduce phase shifts relative to the cells in other branches, with the purpose of reducing the RMS current across the output capacitors. The output capacitors are in parallel, and they are connected in between V+, 510 and GND, 150. The phase shift in between the branches is function of the number of branches. For example, in U.S. Pat. No. 12,462,973, there are two branches and the phase shift is T/4, wherein T is the period of the frequency at which the power cells operate.

Phase shifting between cells reduces RMS current in output capacitors. With more branches and optimal phase shift, the load receives nearly DC output with minimal ripple.

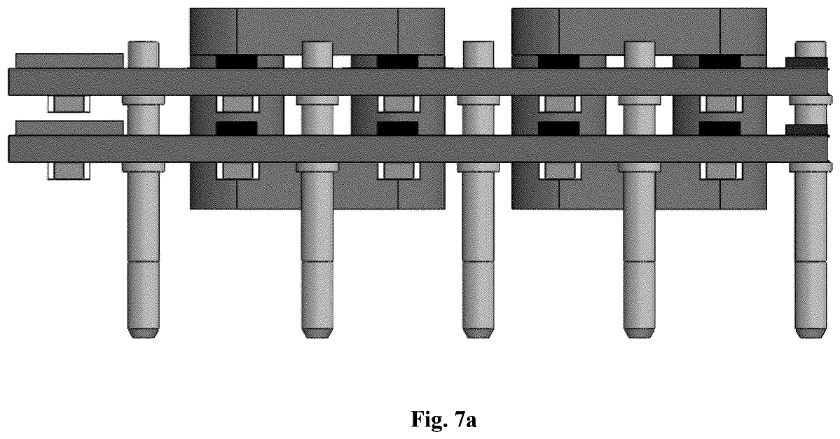

For very high current applications there are multiple multilayers PCB boards each one containing power cells which injects output current via power pins and the power pins are connecting via the male-female power pins form a board to another and further to the mother board as depicted in FIG. 6a. The output capacitors of all the cells of all branches are in parallel. Each power cell in every branch injects a given current into the common plane, 130. In lower power applications there is only one multilayer PCB board having at least one branch with power processing cells. Pins are inserted into the multilayer PCB to the conductive pads of each power processing cells, to Vo+ connection, 510 and ground connection, 150. In some applications there are two layers, referred to as current collector layers, inside of the multilayer PCB, 340, from FIG. 3a, one layer connected to Vo+, 510, and the other one connected to the GND, 150. The vias are placed to said layers inside of the multilayer PCB and to the conductive pads connected to Vo+, 510 and GND, 150.

The power cells of different branches can be placed on the same multilayer PCB board and through vias connected to current collector layers. An alternative approach involves using power pins to draw current from power processing cells onto the main PCB, directing it to current collection layers that are integrated with the motherboard.

In another version, power cells for each branch are mounted on the same multilayer PCB without magnetic cores. Multiple identical PCBs are stacked and connected by conductive pins. U cores are inserted through apertures in each PCB to complete the magnetic path. The arrangement of the multilayer PCB is designed for this purpose.

Each branch has a “n” number of cells and a set of power switchers as depicted in FIG. 2. In FIG. 2 is presented a resonant topology formed by a input voltage source Vin, 260, a totem pole switch structure formed by an upper switch Q1, 270, and a lower switch Q2, 280. Further there is a resonant capacitor Cr connected in between the switching node A, 290 and the primary of the chain of transformers Tr1, Tr2 to Trn, each transformer being part of a power processing cell. In the secondary for each power cell there is a minimum of 2 SR per each polarity. The first polarity, “A”, wherein a positive voltage is induced in the secondary winding of the transformer Tr1, at the dot, 235, the current flows via SR1, 220, and SR1′, 230. to the output capacitors Co1, 200, and Co1′, 210. The second polarity, polarity “B”, wherein a negative voltage is induced in the secondary at the dot, 235, the current flows via SR2, 225, and SR2′, 235. to the output capacitors Co2, 240, and Co2′, 250. The center tap of the secondary winding is connected to the V+, 510 and the sources of the synchronized rectifiers, SR1, SR1′, SR2, SR2′ are connected to the secondary ground, GND, 150. The output capacitors Co1, Co1′, Co2 and Co2′ are connected in between V+, 510 and secondary ground, 150.

There are applications in which the output voltage may have to be regulated within a certain range. In such cases, the leakage inductance has to be larger and an inductor element LR, 444, is placed in series to the n power processing cells. By modulating the frequency of operation, the output voltage Vo+ can be regulated. This magnetic-electrical planar structure which includes also a resonant inductor as part of the power processing cells is another embodiment of this specification and this embodiment is depicted in FIG. 2x.

The power processing cell presented in FIG. 2 is implemented into a multilayer PCB board as depicted in FIG. 3a. It is formed with a multilayer PCB 340, having apertures 300 and 310 and on the top layer surface mounted capacitors, 200, 210, and synchronized rectifiers 230, 220. A magnetic core 320, formed by a plate 330 and two cylindrical posts, 340, as depicted in FIG. 4, are penetrating through said apertures forming the magnetic core of said power processing cell. On the other side of the PCB 340 are placed the capacitors Co2, 240, Co2′, 250, the SR2, 225 and SR2′, 235. A power processing cell has magnetic core 320, surface-mounted components on both sides of multilayer PCB 340, and conductive pads connecting output capacitors (Co1, Co1′, Co2, Co2′) and synchronous rectifiers (SR1′, SR1, SR2, SR2′).

In FIGS. 2a and 2b, the implementation of the power processing cell is presented on the top layer and bottom layer. FIG. 2a shows apertures 300 and 310, along with the magnetic field polarity through posts 340 and 345 from FIG. 4. FIGS. 2a and 2b illustrate the magnetic field generated by current in the primary winding: 338 and 337 for phase “A”, and 336 and 339 for phase “B”. The rate of change of the magnetic field within the magnetic core 320 generates a current in the conductive material encasing apertures 300 and 310. We define the phase “A” as the secondary current flow wherein the secondary voltage across the secondary is positive at the dot, 235, from FIG. 2. We define the phase “B” the secondary current flow wherein the secondary voltage across the secondary is positive at the dot, 235, from FIG. 2. The secondary current, 160, flows counterclockwise from Ground, 150, through SR1, across the top layer of the multilayer PCB, 340, between apertures, and through output capacitor Co1, 200. Similarly, near other apertures, 310, current 170 flows clockwise via SR1′, 230, between apertures, and through output capacitor Co1′, 210.

On the bottom side the current flow is depicted in FIG. 2b. During phase “B” the current flow through the components on the bottom side occur when the polarity of the magnetic field induced in the magnetic core 320 is as depicted by 336 and 339 from FIG. 2b. The current flows in a clockwise direction from ground (150), proceeds through SR2 (225), and continues through capacitor Co2 (240). The secondary current also flows through the conductive material which surrounds the aperture 310. The current flow through the conductive material surrendering the aperture 310. Flows counter clock from the ground 150, through the DR2′ and further through the conductive material in between the two apertures, 300 and 310, and further into the output capacitor Co2′. The current flowing during the phase A charges the capacitor Co1, 200, and Co1′, 210. The current flowing during the phase “B” charges the capacitor Co2, 240, and Co2′, 250.

Preferably, the output capacitors from each cell (e.g., Co1, Co1′, Co2, Co2′ from cell 1) is connected in parallel with the output capacitors of all other cells.

In one of the embodiments of this specification in the multilayer PCB 340, there are at least one layer dedicated to Ground and another player dedicated to Vo+, 510. These two layers are connected to the Vo+, 510 and GND, 150 of each cell through conductive vias.

In another preferred embodiment, the connection to Vo+, 510 and GND, 150 of each cell are electrically connected to pins which are pressed in the multilayer PCB 340. In FIG. 3a, the pin P500 and pin P530 are connected to the ground. The pins P510 and pin P520 are connected to Vo+. When multiple identical multilayer PCB boards are placed on top of each other the pins may be also connected to Ground and Vo+ of the other multilayer PCBs which are stacked on top of each other. The pins are further connected to a mother board which extracts the current injected by each cell in Vo+ plane towards the Ground plane.

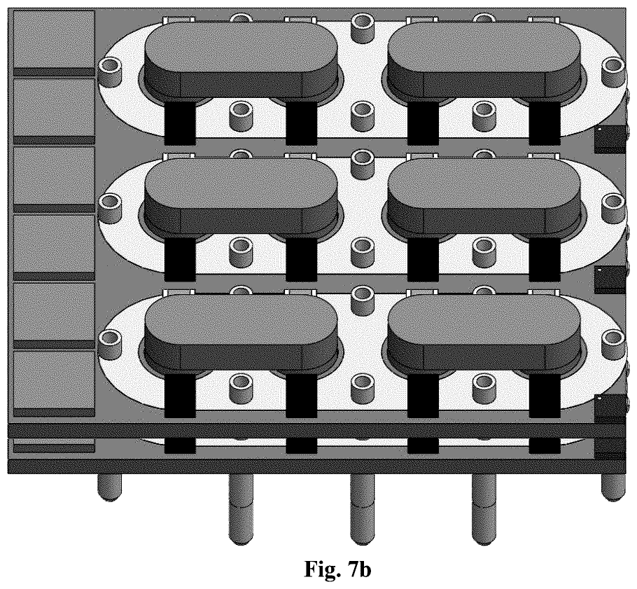

FIGS. 6a and 6b show a method of using two multilayer PCBs stacked together, with power processing cells connected by pins. In FIG. 6a each multiplayer PCB has independent magnetic cores placed through the apertures of each cell. In FIG. 7a and FIG. 7b, the magnetic cores penetrated through a number of multilayer PCB board. The embodiment shown in FIGS. 6a and 6b does not require vertically arranged power processing cells on each multilayer PCB to be identical or synchronized. However, this design results in a taller planar magnetic-electrical power train compared to structures where magnetic cores penetrate through apertures in each multilayer PCB. Conversely, when vertical cells are made identical and synchronized, the planar magnetic-electrical power train's height is reduced.

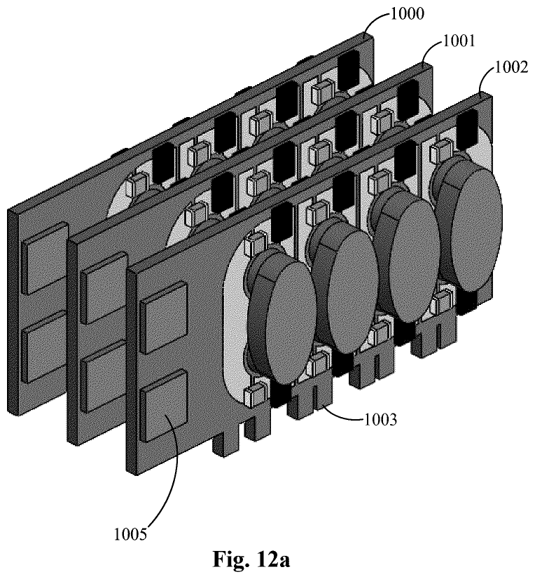

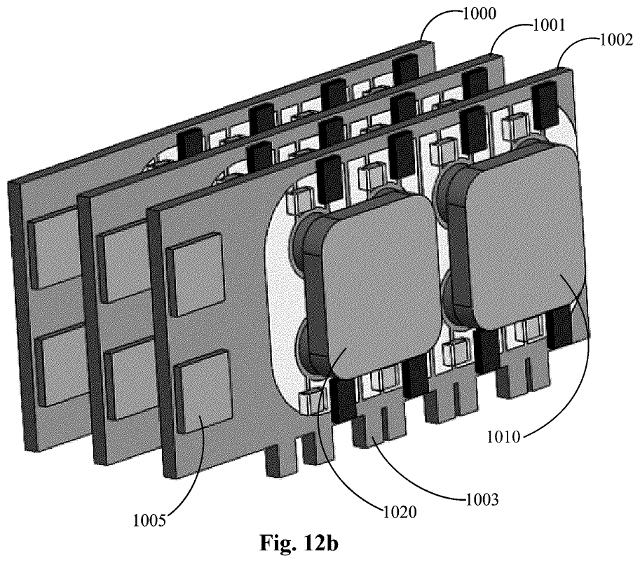

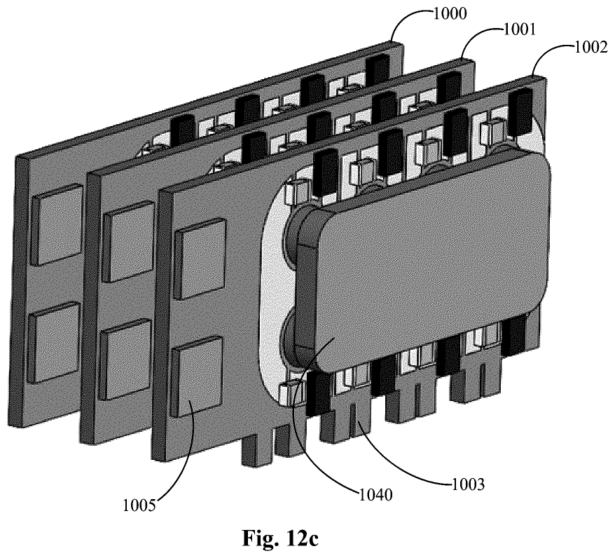

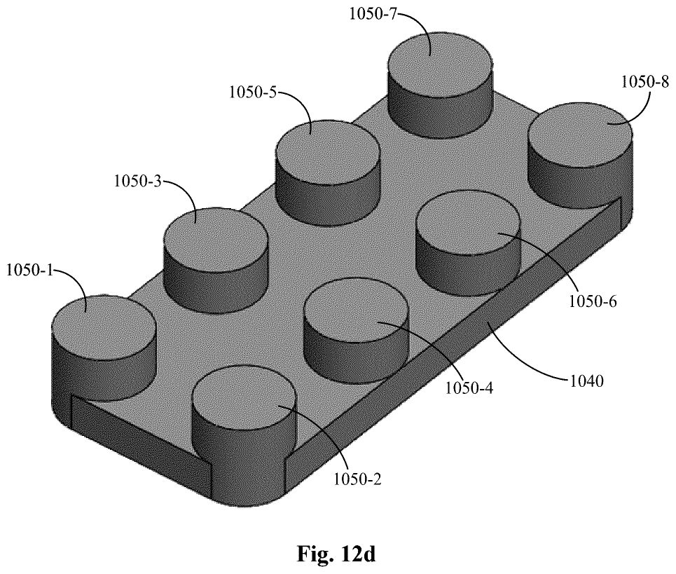

FIG. 12a presents another embodiment of this specification: a Converter constructed with three multilayer PCBs (1000, 1001, and 1002), each forming a phase branch with an inter-branch phase shift. Every branch has four processing cells, each paired with a U core; for PCB 1002, these are cores 1006-1009. Each cell features two synchronized rectifiers on either side, totaling 16 per branch. Vo+ (510) and GND (150) connect to inner layers on the multilayer PCB, carrying current from output capacitors to connectors (1003) and the motherboard. Output capacitors are paralleled along dedicated Vo+ and GND layers, reducing ripple by roughly tenfold.

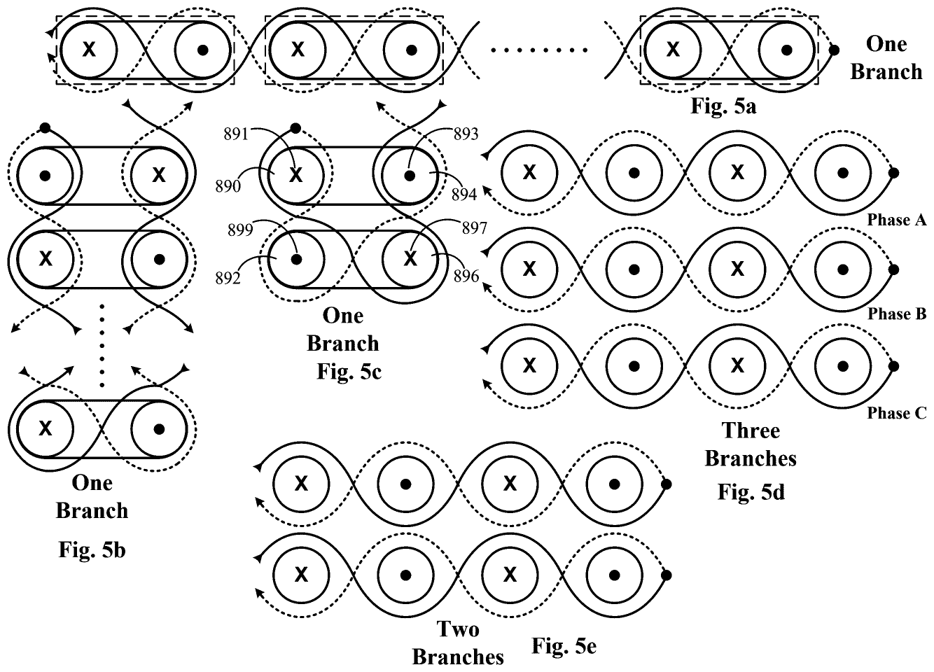

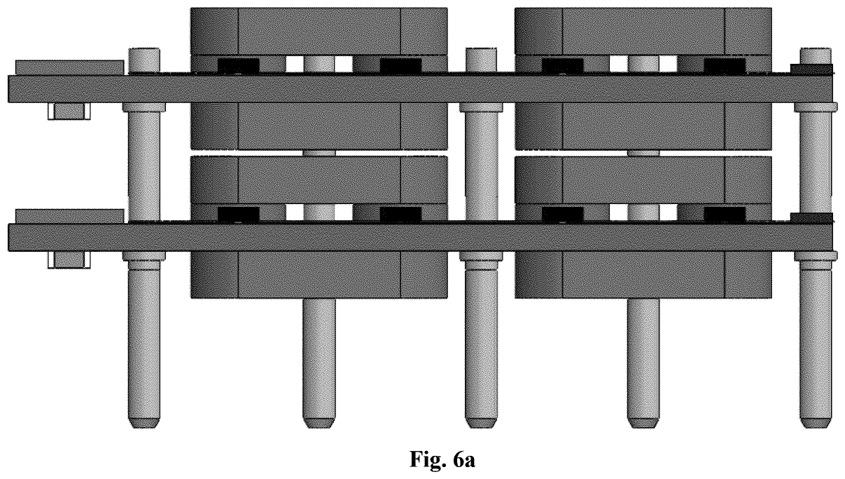

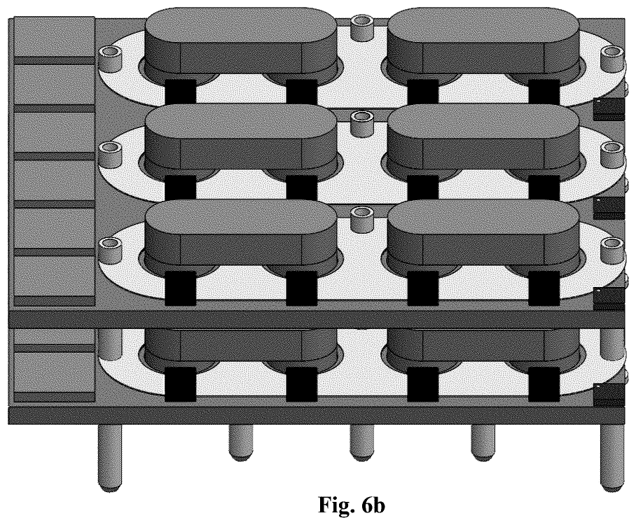

FIG. 5b shows that every two U cores (with eight magnetic posts) can share a single plate (as in FIG. 12b: plates 1010 and 1003), halving flux density through the plate and allowing thinner plate. In FIG. 12C, all eight posts use one magnetic plate (1040), matching the thickness of plates in FIG. 12b.

FIG. 12d details another embodiment with a merged magnetic core from four U cores, supporting four power processing cells. The setup in FIG. 12c enables each branch to deliver 3.3 KW from an 800V input, outputting 12V at 275A, resulting in high power density and straightforward air cooling via vertical PCB mounting and wind tunnel effects. Dissipation occurs mainly on the top and bottom layers of each PCB, with optional liquid cooling. Primary switches are also situated on each PCB. This design is simple, efficient, and preferred.

### Full Bridge Rectification

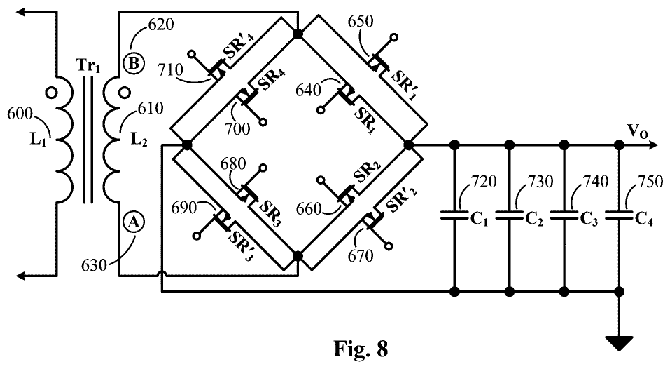

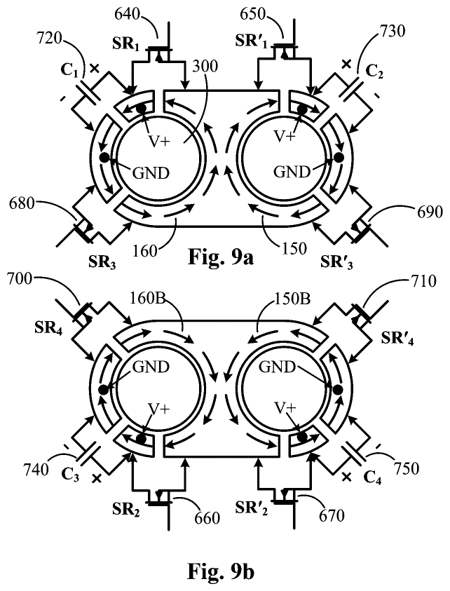

FIG. 8 presents a power processing cell using full bridge rectification. This may be useful in applications of higher output voltage such as 48V wherein low voltage and low impedance synchronized rectifiers can be used. FIGS. 8, 9a, and 9b depict a power processing cell similar to the power cell depicted in FIGS. 2a and 2b, containing a transformer Tr1, having a primary winding L1, 600, and a secondary winding L2, 610. A full bridge rectification circuit is formed by SR1, 640, SR1′, 650, SR2, 660, SR2′, 670, SR3, 680, SR3′, 690, SR4, 700, SR4′, 710. There are four output capacitors C1, 720, C2, 730, C3, 740 and C4, 750.

During the phase “A”, the voltage induced in the conductive material on the top layer of the multilayer PCB 340, surrounding the aperture 300, creates a current 160, flowing counter clock through the SR3, 680, and SR1, 640 charging the capacitor C1, 720. In the same time during the phase “A” a current is also induced through the conductive material surrounding the aperture 310, flowing clockwise, vias SR1′, 650, SR3′ charging the capacitor C2, 730.

During the phase “B”, the voltage induced in the conductive material on the bottom layer of the multilayer PCB 340, surrounding the aperture 300, creates a current 160B, flowing clock wise through the SR4, 700, and SR 2, 660 charging the capacitor C3, 740. In the same time during the phase B a current, 150B, is also induced through the conductive material surrounding the aperture 310, flowing counterclockwise, via SR2′, 670, SR4′, 710, charging the capacitor C4, 750.

### Primary Winding

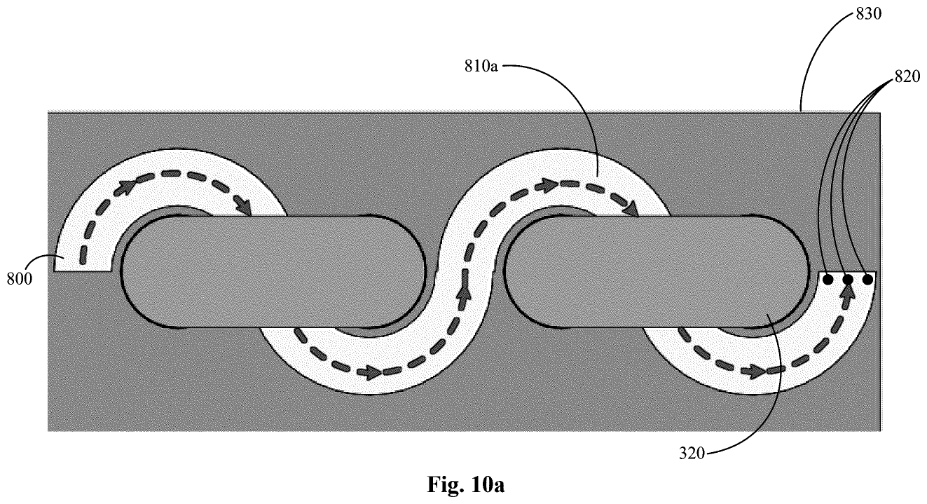

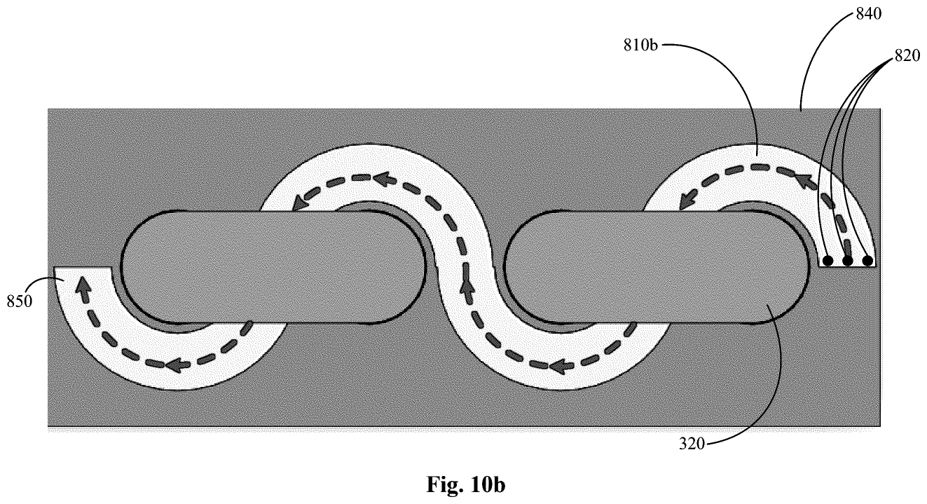

The primary winding can be implemented wherein the traces which are part of the primary winding surround the magnetic post of the U cores once or several times, or using a serpentine winding, as depicted in FIG. 10a, and FIG. 10b. The serpentine winding, 810a and 810b located on layer 830 and layer 840 is originated in 800 and goes in between the legs of the U core 320, to the next U core waving through the posts of the U cores of the power processing cells until arriving to the vias 820 wherein the trace 810a is electrically connected through vias on the layer 840, and the serpentine windings 810b, continues to go through further through the legs of the U core forming a complete turnaround each leg of the U cores, ending at 850.

This method of winding does not utilize the copper which surrounds the other half of the U core post opposite the serpentine trace. In conclusion, just half of the copper in the vicinity of the magnetic posts is used. The distance between posts of the U core can be reduced to the width of the serpentine winding. In the traditional winding technique wherein, complete turns are implemented around each post the distance in between two posts has to be equal or larger than the width of the primary winding trace. A reduced distance between the posts reduces the volume of the magnetic core and reduces also reduces the distance between the magnetic post to the next magnetic cell. For a reduced number of turns the serpentine winding is a very good solution though for a large number of turns the serpentine winding increases the height of the primary windings layers.

### Primary Core Arrangements for Flexibility

This specification outlines a planar magnetic-electrical power train utilizing a dual-leg U core as its fundamental building block, allowing adaptability across multiple form factors. Power converters can be configured in various ways with this core. FIG. 5a displays an inline arrangement of U cores, where the primary winding follows a serpentine path through each core. While conventional winding methods are also feasible, the core configuration remains consistent; the serpentine pattern serves to highlight the flexible positioning of the U cores.

Another configuration is illustrated in FIG. 5b, featuring U cores arranged parallel to one another, forming a column with greater width and reduced length compared to FIG. 5a. A related configuration is shown in FIG. 5c, which presents a four-leg magnetic structure.

For applications that require multiple branches—such as interleaved multiphase systems where each branch aligns in an inline arrangement as depicted in FIG. 5a—the setup is demonstrated in FIG. 5d. For two-phase implementations, the preferred arrangement is illustrated in FIG. 5c.

A magnetic structure built from U cores offers enhanced flexibility and can accommodate a wide range of form factors effectively.

FIG. 5c shows a primary winding that generates a magnetic field in the posts of two U cores as depicted by the magnetic field orientation given by (891, 899, 893, 897). The four posts (890, 892, 894, and 896) have alternating magnetic polarity, the polarity through each post has an opposite polarity to the adjacent post, resembling the four-leg magnetic core described in U.S. Pat. No. 10,937,590. If the I section of both U cores are combined into a single plate with all four posts, the flux density in the plate is half that of each post. The structure from FIG. 5C can be extended to a eight posts wherein we can have only one plate on both sides. It does offer an easier manufacturing process though for eight legs the thickness of the plate is the same as for the four leg configuration. The arrangement shown in FIG. 5c is also suitable for three pairs of dual post cores. In this scenario, the flux passing through the plate is split into three parts over the section that covers the middle magnetic posts, and divided by two across the rest of the plate. To sum up, for the set of magnetic posts illustrated in FIG. 5b, if the plate covers all the magnetic posts, the maximum flux density through the plate is less than half the magnetic flux density through the posts, and no more than half the total flux through the posts.

An example of flexibility of the multiple U core solution is derived from FIG. 12d, wherein there are used four, U cores, which means 8 magnetic posts. One derivation of four U cores (8 magnetic posts) is depicted in FIG. 12b, wherein we use two four leg core, 1020, with the primary in series with another four leg transformer, 1020. The thickness of the plate of the cores, 1020 and 1010 is half of what would have been for a plate of a U core having only two magnetic posts.

Another derivation of the concept depicted in FIG. 5b, is presented in FIG. 12d, wherein the four U cores are merged using only one magnetic plate 1040. The magnetic structure depicted in FIG. 12d has eight magnetic posts, 1050-1, 1050-2, 1050-3, 1050-4, 1050-5, 1050-6, 1050-7, 1050-8. In FIG. 12C is presented an implementation of such a merged core, merged from 4 U core, dual magnetic posts core. FIG. 12C depicts a 10 KW DCX transformer wherein each board produces 3.3 KW for 12V @ 175A.

Using a larger number of dual magnetic posts, each one with a power processing cell is the simplification of the primary winding, and the reduction of the number of turns per each magnetic of the power processing cell, which makes it very suitable for serpentine winding.

### Fractional Turns

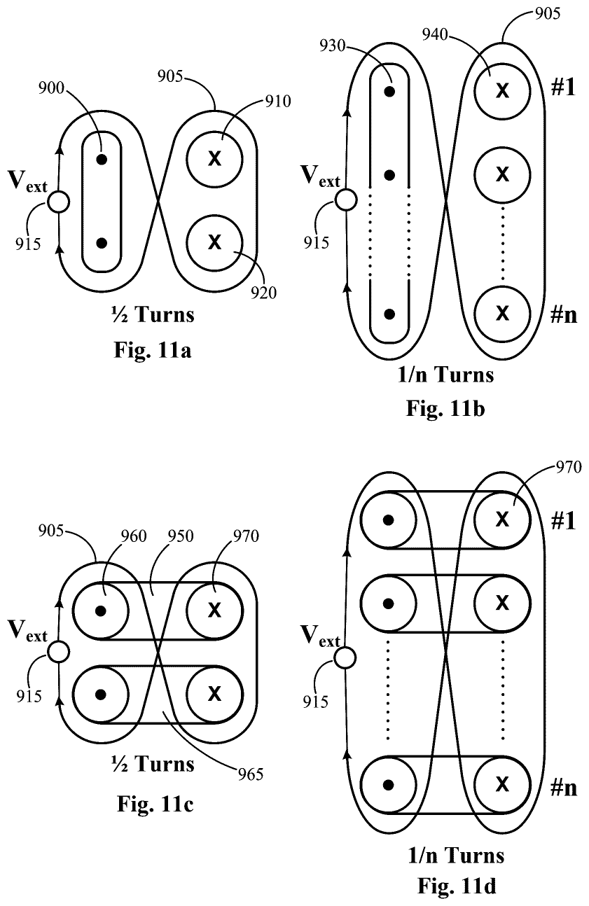

Fractional turns are essential in some applications. This specification outlines a methodology using modular power processing cells, allowing any power train configuration and supporting fractional turns. For example, to achieve a 6V output for a step-down, high-current DC transformer (DCX), a magnetic core with two narrow legs (910, 920) and one wider leg (900) is used, as shown in FIG. 11a. The primary winding (905) passes through the core twice; a one-turn secondary winding around posts 910 or 920 induces half the excitation voltage (Vext/2, 915).

FIG. 11b illustrates a core with n narrow legs (#1-#9) and a wide leg (930). A secondary winding around one narrow leg receives 1/n of Vext. FIG. 11c shows two U cores (950, 960); winding the primary as in FIG. 11a, a secondary winding encircling posts 960 or 970 produces Vext/2. In FIG. 11d, a group of n cores has a secondary winding around a single post, yielding Vext/n.

This approach enables fractional turns using power processing cells equipped with U cores.

### Control of Multiple Branches in Order to Reduce the RMS Current Through the Output Capacitors and Reduction of the Common Mode Noise.

FIG. 1 shows a power system with multiple branches, each one using multiple power processing cells. For voltage step-down and high-current applications, the LLC topology operates near resonance. Though this solution has advantages, such as ZVS and near zero current switching, it has the disadvantage of high RMS current through output capacitors. A two-branch system with a phase shift of T/4 reduces capacitor RMS current by about five times. Using three phases with a T/3 shift can reduce RMS current by ten times. Multiple branches also allows one to increase system output power.

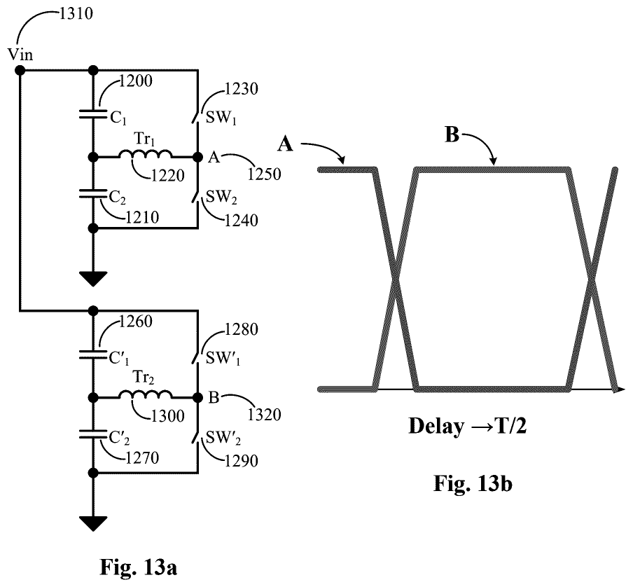

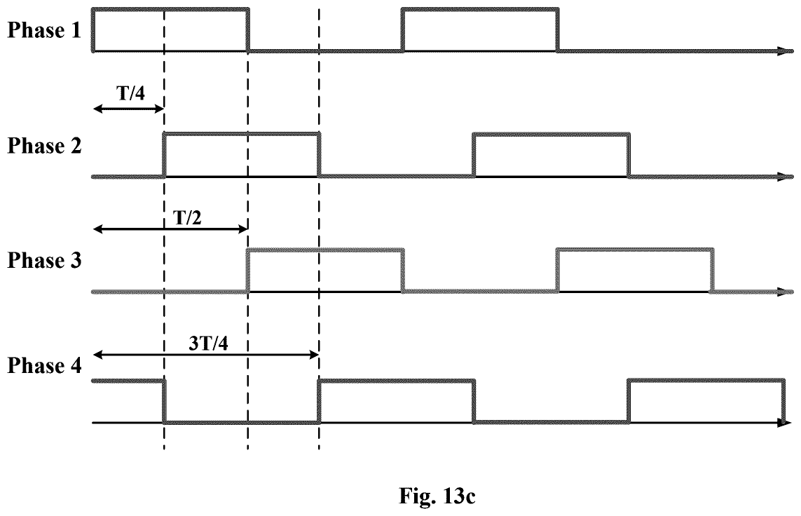

The multiple branches solution helps lower common mode noise. FIG. 13a illustrates two half bridges used in LLC topologies, having switching nodes A and B. At very high frequencies (e.g., 1 MHz) and input voltages (e.g., 800V for AI applications), dV/dt at these nodes is significant, causing displacement current via parasitic capacitances between primary to secondary windings of the transformers. Operating two half bridges with a T/2 delay (FIG. 13b) cancels common mode noise due to opposite displacement currents.

FIG. 13c presents a four-branch system with T/4 delays between power trains. Phase-shifted branches minimize RMS current through output capacitors and enable noise cancellation between pairs separated by T/2. In summary, utilizing four branches with appropriate phase delays reduces both RMS current and common mode noise.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. Power processing cells comprising:
a magnetic element comprising identical magnetically conductive first and second posts positioned between two magnetic flux conductive plates, wherein the plates are configured to ensure a continuous flow of a magnetic field through the first and second posts;
a multilayer electrically conductive structure with openings for the first and second posts, containing stacked layers wherein at least one of the layers forms primary and secondary transformer windings;
the primary transformer winding is located within the multilayer electrically conductive structure, encircling the first and second posts, each with an induced magnetic field of opposite polarity to the other;
the secondary transformer winding comprises at least two secondary layers in the multilayer electrically conductive structure, with one of the secondary layers at a top and another of the secondary layers at a bottom;
semiconductor devices on at least one of the secondary layers, electrically connected to the secondary transformer winding;
output capacitors on at least one of the secondary layers, electrically connected to the secondary transformer winding and the semiconductor devices; and
electrically conductive pads positioned between the first and second posts, and electrically connected to the semiconductor devices and the output capacitors;
wherein a current is induced through the semiconductor devices, the output capacitors, and the electrically conductive pads around the first and second posts, by the magnetic field from a current flow of the primary transformer winding; and
said current flow generates a voltage across the output capacitors, with one termination at a Vo+ terminal and the other at a GND terminal;
wherein all of the output capacitors are connected in parallel within the power processing cells, the Vo+ terminals are electrically joined, and the GND terminals are electrically joined, wherein shared GND and Vo+ terminals define a common ground and a positive output, respectively.

2. A planar magnetic-electrical power train branch comprising:
a frequency of operation and a period T, wherein period T is an inverse of the frequency of operation;
a primary and a secondary;
an input power source in the primary;
an output in the secondary;
at least two totem pole power devices connected to the input power source;
a resonant capacitor connected to a common connection of the at least two totem pole power devices, defining a switching node;
a plurality of power processing cells according to claim 1, wherein the primary transformer windings of said power processing cells are connected in series and further connected to the resonant capacitor.

3. The planar magnetic-electrical power train branch of claim 2, wherein each of the power processing cells further comprising at least one inner layer forming an external ring encircling an outside of both the first and second posts.

4. A planar magnetic-electrical power train comprising multiple planar magnetic-electrical power train branches according to claim 2, wherein each branch operates at a same frequency and is successively delayed by a fraction of T, so as to reduce RMS current across the output capacitors in all the power processing cells of every branch.

5. A planar magnetic-electrical power train comprising an even number of planar magnetic-electrical power train branches according to claim 2, wherein the branches are arranged in pairs and each pair operates at a same frequency but is offset by T/2 relative to the other, so as to cancel out common mode noise generated by a displacement current across a parasitic capacitance between the primary and secondary transformer windings of each processing power cell transformer.

6. A planar magnetic-electrical power train comprising multiple planar magnetic-electrical power train branches according to claim 2, each comprising power processing cells within one multilayer conductive structure, wherein the Vo+ and GND connect to pins interfacing with a motherboard which aggregates current from all of the power processing cells via the pins.

7. A planar magnetic-electrical power train comprising multiple planar magnetic-electrical power train branches according to claim 2, each comprising power processing cells within a plurality of multilayer conductive structures, wherein the Vo+ and GND connect to pins interfacing with a motherboard which aggregates current from the plurality of multilayer conductive structures via the pins.

8. A planar magnetic-electrical power train comprising multiple planar magnetic-electrical power train branches according to claim 2, each comprising power-processing cells within a multilayer conductive structure wherein in each branch, an even number of magnetic posts are between the magnetically conductive plates covering said posts.

9. A planar magnetic-electrical power train comprising multiple planar magnetic-electrical power train branches according to claim 2, wherein each branch includes power processing cells embedded within a multilayer electrically conductive structure, and the first and second posts of each branch are inserted into the multilayer conductive structure and are positioned between magnetically conductive plates that fully enclose all posts.

10. A planar magnetic-electrical power train comprising multiple planar magnetic-electrical power train branches according to claim 2, wherein each branch is implemented on a distinct multilayer electrically conductive structure formed by the power processing cells, wherein Vo+ and GND are interconnected through internal layers and are inserted and electrically connected within a motherboard which aggregates current from all of the power processing cells across every branch.

11. The planar magnetic-electrical power train of claim 10, wherein each branch operates at a same frequency and is sequentially delayed by a fraction of T, so as to reduce RMS current through the output capacitors in every power processing cell.

12. The planar magnetic-electrical power train of claim 10, wherein the branches are arranged in pairs and each pair operates at a same frequency but is offset by T/2 relative to the other, so as to cancel out common mode noise generated by a displacement current across a parasitic capacitance between the primary and secondary transformer windings of each processing power cell.

13. The planar magnetic-electrical power train branch of claim 2, further comprising multiple power processing cells, wherein each primary transformer winding is configured around the first and second posts of each respective power processing cell to establish fractional turns within the respective power processing cell.

14. A power processing cells comprising:
a magnetic element comprises two identical magnetically conductive first and second posts between two magnetic flux conductive plates, wherein the plates are configured to ensure a continuous flow of a magnetic field through the first and second posts;
a multilayer electrically conductive structure with openings for the first and second posts, containing stacked layers wherein at least one of the layers forms primary and secondary transformer windings;
the primary transformer winding is located within the multilayer electrically conductive structure, encircling the first and second posts, each with an induced magnetic field of opposite polarity to the other;
the secondary transformer winding comprises at least two secondary layers in the multilayer electrically conductive structure, with one of the secondary layers at a top and another of the secondary layers at a bottom;
at least two semiconductor devices in series on at least one secondary layer, electrically connected to the secondary transformer windings;
output capacitors on at least one of the secondary layers, electrically connected to the secondary windings and semiconductor devices; and
electrically conductive pads positioned between the first and second posts, and electrically connected to the semiconductor devices and the output capacitors;
wherein a current is induced through the semiconductor devices, the output capacitors, and the electrically conductive pads around each of the first and second posts, by the magnetic field from a current flow of the primary winding; and
said current flow generates a voltage across the output capacitors, with one termination at a Vo+ terminal and the other at a GND terminal;
wherein all of the output capacitors are connected in parallel within the power processing cells, the Vo+ terminals are electrically joined and the GND terminals are electrically joined, wherein shared GND and Vo+ terminals define a common ground and positive output.
